(19) United States
(12) Patent Application Publication
(10) Pub. No.: US 2018/0266216 A1
(43) Pub. Date: Sep. 20, 2018

(54) DOWNHOLE GENERATOR SYSTEM

(71) Applicant: SCHLUMBERGER TECHNOLOGY CORPORATION, Sugar Land, TX (US)

(72) Inventors: Mustafa Kamil GUVEN, Katy, TX (US); Torgeir RUSTEN, Gloucestershire (GB); In Chul JANG, Sugar Land, TX (US)

(21) Appl. No.: 15/762,408

(22) PCT Filed: Sep. 21, 2016
(86) PCT No.: PCT/US2016/052729

§ 371 Date: Mar. 22, 2018

Related U.S. Application Data
(60) Provisional application No. 62/221,695, filed on Sep. 22, 2015.

(51) Int. Cl. E21B 41/00; H02M 1/32; H02M 3/06; H02M 7/219; H02P 9/34

(52) U.S. Cl. CPC E21B 41/0085; H02M 1/32; H02P 9/34; H02M 7/219; H02M 3/06

(57) ABSTRACT

A downhole generator system including a controlled rectifier for receiving electrical power from a generator and outputting rectified electrical power. A control system controls the operation of the controlled rectifier and a chopper circuit connected to the output of the controlled rectifier connects a load selectively across the output of the controlled rectifier to regulate the output of the generator system. The control system controls the chopper circuit and/or the controlled rectifier based at least in part on a feed-back signal representative of an electric current output by the generator system and an electric current passing through the chopper circuit.

### CROSS-REFERENCE TO RELATED APPLICATION

The present document is based on and claims priority to U.S. Provisional Application Ser. No.: 62/221695, filed Sep. 22, 2015, which is incorporated herein by reference in its entirety

### BACKGROUND

Embodiments of the present disclosure relate to a generator system and associated methods. In particular, some embodiments relate to a generator system for use in relation to downhole equipment.

Controlled rectifiers are commonly used to convert an alternating current (AC) electrical power input from a generator into a desired direct current (DC) electrical power output. In many modern applications, the generator may be an induction motor-generator or a permanent magnet motor-generator which can also act as a motor. As such the controlled rectifier may also act as an inverter to drive the motor-generator.

Controlled rectifiers of this type form part of a generator system which may be included in a number of different applications. This may include, for example, use in equipment which is located within a borehole penetrating the Earth—i.e. downhole equipment.

The electrical power generated by the generator system may be used by other equipment (which may also be downhole equipment).

There is a need to provide such controlled rectifiers which can react quickly to variations in the power output by the motor-generator and/or changes in the load.

There may also be a need to control the speed of rotation of a shaft of the generator when the generator is generating and the generator system is operating as a controlled rectifier. This may, for example, be necessary for steering downhole equipment on a drillstring or the like.

Accordingly embodiments of the present disclosure seek to alleviate one or more problems associated with the prior art.

SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set.

An aspect of embodiments of the present disclosure provides a generator system including a controlled rectifier that receives electrical power from a generator and outputs rectified electrical power. The generator system also includes a control system to control the operation of the controlled rectifier and a chopper circuit connected to the output of the controlled rectifier connects a load selectively across the output of the controlled rectifier to regulate the output of the generator system. The control system controls the chopper circuit and/or the controlled rectifier based at least in part on a feedback signal representative of an electric current output by the generator system and an electric current passing through the chopper circuit.

The control system may further include a controller configured to compare the voltage output by the generator system with a predetermined voltage and to determine a further feedback signal based at least in part on the difference between the voltage output by the generator system and the predetermined voltage, where the control system is further configured to control the operation of the chopper circuit and/or the controlled rectifier based on the further feedback signal.

The control system may be configured to control the operation of the chopper circuit and/or the controlled rectifier based on the sum of the feedback signal and the further feedback signal.

The feedback signal may be determined based at least in part on the sum of a signal representative of electric current output by the generator system and a signal representative of the electric current passing through the chopper circuit.

The control system may include a field oriented control module.

The control system may be further configured to receive a generator speed control signal and to control the operation of the chopper circuit and/or the controlled rectifier based at least in part on the generator speed control signal.

The chopper circuit may be configured to regulate the electric voltage output by the generator system.

The chopper circuit may be configured to reduce the speed of rotation of a shaft of a generator coupled to the generator system.

Another aspect of some embodiments of the present disclosure may provide a generator system and generator, wherein the generator system comprises a generator system as described above and the generator is configured to supply electrical power to the generator system for conversion by the generator system into the output rectified electrical power.

The generator may include a three phase generator.

Another aspect provides downhole equipment including a generator system as described above.

The downhole equipment may be configured to operate down a borehole.

Another aspect of some embodiments of the present disclosure provides a method of controlling a generator system. In this method a feedback signal representative of an electric current output by the generator system and an electric current passing through a chopper circuit of the generator system; is received and the operation of a controlled rectifier and/or a chopper circuit is controlled/managed, based at least in part on the feedback signal, to provide a rectified electrical power output from the generator system.

The method may further include comparing the voltage output by the generator system with a predetermined voltage and to determine a further feedback signal based at least in part on the difference between the voltage output by the generator system and the predetermined voltage; and controlling the operation of the chopper circuit and/or the controlled rectifier based on the further feedback signal.

The method may further include: controlling the operation of the chopper circuit and/or the controlled rectifier based on the sum of the feedback signal and the further feedback signal.

The method may further include: determining the feedback signal based at least in part on the sum of a signal representative of electric current output by the generator system and a signal representative of the electric current passing through the chopper circuit.

Controlling the operation of the chopper circuit and/or the controlled rectifier may include using a field oriented control method.

The method may further include: receiving a generator speed control signal; and controlling the operation of the chopper circuit and/or the controlled rectifier based at least in part on the generator speed control signal.

The method further include regulating the electric voltage output by the generator system using the chopper circuit.

A method may further include reducing the speed of rotation of a shaft of a generator coupled to the generator system using the chopper circuit.

### BRIEF DESCRIPTION OF THE DRAWINGS

The present disclosure is described in conjunction with the appended figures. It is emphasized that, in accordance with the standard practice in the industry, various features are not drawn to scale. In fact, the dimensions of the various features may be arbitrarily increased or reduced for clarity of discussion.

FIG. 1 is a simplified schematic view of a system of embodiments; and

FIG. 2 is a simplified schematic view of some embodiments.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the scope of the invention as set forth in the appended claims.

Specific details are given in the following description to provide a thorough understanding of the embodiments. However, it will be understood by one of ordinary skill in the art that the embodiments maybe practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

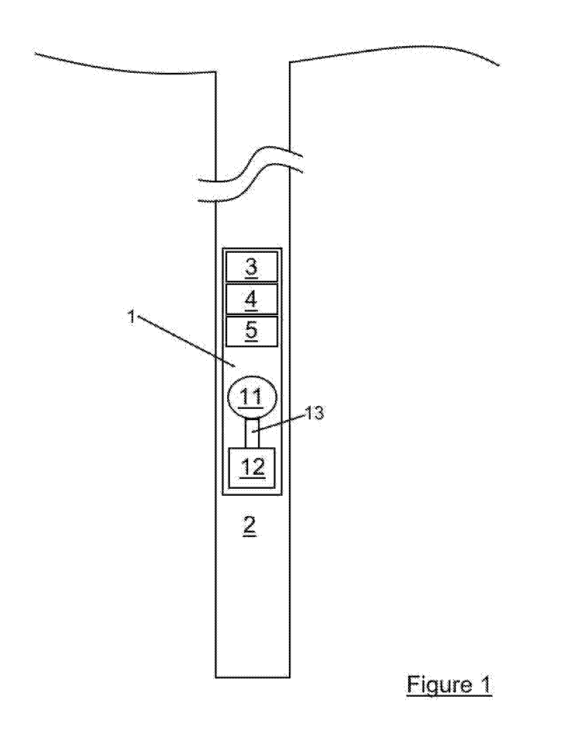

With reference to FIG. 1, some embodiments of the present disclosure include downhole equipment 1 which is configured to be lowered into a borehole 2 which may be used for the exploration and/or of water or hydrocarbons such as natural gas and/or oil. Equally, the borehole 2 may be used in geological surveying, for example.

The downhole equipment 1 may include a drill string which includes a bottomhole assembly and drill pipe, for example. In some embodiments, the drillstring is steerable—i.e. the drill string can be steered off a straight longitudinal course to extend the borehole in a desired direction.

The downhole equipment 1 includes at least one generator or motor-generator 11 (which may be part of the bottomhole assembly or which may be part of another portion of the drillstring). The generator or motor-generator 11 may be an induction motor or a permanent magnet motor, for example, and in some embodiments may be a three-phase induction motor or permanent magnet motor.

In some embodiments, a rotatable shaft 13 of the generator or motor-generator 11 is coupled to a propeller 12 (which may in some aspects be part of an impeller). The propeller 12 may be configured to be driven by the flow of a fluid (e.g. drilling fluid or “mud”) through or around at least part of the downhole equipment 1. In addition or alternatively, in some embodiments, the propeller 12 may be configured to drive the flow of fluid through or around at least part of the downhole equipment 1. In some embodiments, the generator or motor-generator 11 may be configured to drive (or be driven by, as the case may be) some other element of the downhole equipment 1.

The downhole equipment 1 may include a generator system 3 which is configured to rectify electrical power generated by the generator or motor-generator 11 and/or to drive the generator or motor-generator 11.

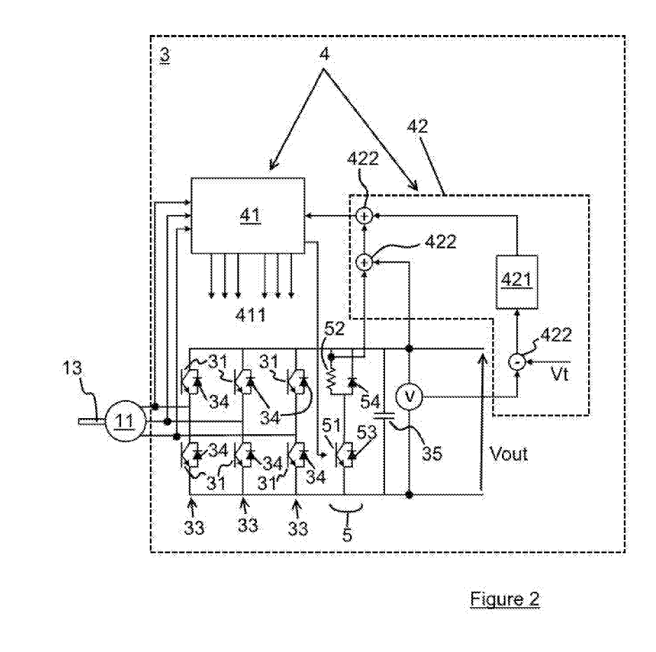

With reference to FIG. 2, the generator system 3 may include a controlled rectifier 31 which, it will be appreciated, may also act as an inverter in some embodiments. The controlled rectifier 31 comprises a plurality of switch devices 32. The switch devices 32 may be connected in one or more legs 33. In some embodiments, each leg 33 includes a pair of switch devices 32 connected in series, but in any event each leg 33 includes at least one switch device 32. In embodiments including a plurality of legs 33, each leg is connected in parallel with the others.

In embodiments in which a multi-phase generator or motor-generator 11 is provided (e.g. a three-phase generator or motor-generator 11), the generator or motor-generator 11 includes a set of windings for each phase. Each winding of the generator or motor-generator 11 is connected in selective electrical communication with a respective leg 33 between the pair of switch devices 32.

The switch devices 32 may each be transistor-based devices—such as insulated-gate bipolar transistors. Each switch device 32 may be connected in parallel with one or more protection devices 34 such as a freewheeling diode (see FIG. 2 for example).

The switch devices 32 are connected in electrical communication with a control system 4 of the generator system 3, which control system 4 is configured to control the actuation of the switch devices 32 in accordance with a control scheme through control signals 411. The control scheme is such that, for example, the desired voltage is output from the generator system 3 and/or delivered to the generator or motor-generator 11. The control system 4 may, therefore, operate in a first mode in which the power control circuit 3 operates as an inverter or a controlled rectifier.

A capacitor 35 may be provided connected in parallel with the switch devices 32 (e.g. across an output of the power control circuit 3, to smooth the voltage at the output). In other words, the capacitor 35 is connected in parallel with the or each leg 33.

Embodiments include a braking chopper circuit 5, which may be part of the generator system 3. The braking chopper circuit 5 may be connected in parallel with the or each leg 33. The braking chopper circuit 5 is configured to provide selectively a load (which may be a resistive load) across the output of the controlled rectifier 31.

Accordingly, the braking chopper circuit 5 may include a chopper circuit switch device 51 and a resistive load 52. The chopper circuit switch device 51 and resistive load 52 are connected in series with each other and in parallel with the one or more legs 31 of the generator system 3 (i.e. in parallel with the output of the generator system 3).

The switch device 51 may be a transistor-based device—such as an insulated-gate bipolar transistor. The switch device 51 may be connected in parallel with one or more protection devices 53 such as a freewheeling diode (see FIG. 2 for example).

The braking chopper circuit 5 may also include a freewheeling diode 54 (or other protection device 54) connected in parallel with the resistive load 52.

The switch device 51 is configured to be actuated between a closed configuration in which the resistive load 52 is connected in electrical communication across the output of the generator system 3 and an open configuration in which the resistive load 52 is not connected in electrical communication across the output of the generator system 3.

The control system 4 may include a field oriented control module 41 which is configured to control the operation of the controlled rectifier 31—in particular, the operation of the switch devices 32.

The control system 4 may further include a braking chopper circuit control module 42. The braking chopper circuit control module 42 may be configured to determine a first feedback signal representative of a difference between the output voltage from the generator system 3, Vₒᵤₜ, (i.e. from the controlled rectifier 31) and a desired output voltage, Vₜ. The desired output voltage may be determined by equipment that is powered by the generator system 3—e.g. the voltage required to power such equipment.

The first feedback signal may be determined by a proportional-integral controller 421—which may be part of the control system 4 and, specifically, part of the braking chopper circuit control module 42.

The proportional-integral controller 421 may be configured to receive a signal representative of the difference between the voltage output and the desired output voltage (i.e. a difference signal). The proportional-integral controller 421 may be configured to output the first feedback signal based on the difference signal.

The braking chopper circuit control module 42 may be further configured to determine a second feedback signal which is representative of a current through the braking chopper circuit 5 and, in particular, through the resistive load 52.

The braking chopper control circuit control module 42 may be further configured to determine a third feedback signal representative of the current drawn by the load on the generator system 3—i.e. the current output by the generator system 3 (e.g. to the equipment powered by the generator system 3).

The braking chopper control circuit control module 42 may be configured to determine a fourth feedback signal based on the second and third feedback signals—for example, the fourth feedback signal may be based on the addition of the second and third feedback signals.

The braking chopper control circuit control module 42 may be configured to determine a fifth feedback signal based on the fourth and first feedback signals—for example, the fifth feedback signal may be based on the addition of the first and fourth feedback signals.

Accordingly, the braking chopper circuit control module 42 may include one or more signal adders and/or subtractors 422.

The fifth feedback signal may, therefore, be representative of the difference between the voltage output by the generator system 3 and the desired output voltage, along with the total current supplied by the generator system 3 (i.e. that output by the generator system 3 to the load and that passing through the resistive load 52 of the braking chopper circuit 5).

The fifth feedback signal may be used by the control system 4 to control the operation of the controlled rectifier 31 and, in particular, the actuation of the switch devices 32. Therefore, the fifth feedback signal may be used by the field oriented control module 41.

As will be appreciated, the control system 4 (e.g. the field oriented control module 41) may be further configured to receive signals indicative of the current and/or voltage output by the generator or motor-generator 11 to the generator system 3. These signals may be used to control the operation of the control system 4 and, in particular, may be used to control the operation of the controlled rectifier 31 (e.g. the actuation of the switch devices 32).

The control system 4 is further configured to output a braking chopper circuit control signal, which controls the operation of the braking chopper switch device 51 (i.e. controls actuation of that device between its open and closed configurations).

Accordingly, in some embodiments, the first feedback signal is largely representative of inefficiencies in the overall operation of the generator system 3 and may, in some embodiments, tend to remain relatively stable during operation (compared to the fifth feedback signal). The fifth feedback signal may provide the majority of the feedback for use by the control system 4. The braking chopper circuit 5 can, therefore, be used to provide relatively fast control and may be used to control the operation of the generator or motor-generator 11.

As a result of the operation of some embodiments, it may be possible to reduce the size (i.e. the capacitance) of the capacitor 35—as the variance in the output of the generator system 4 is less then might otherwise be the case.

The braking chopper circuit 5 can also, in some embodiments, be used to regulate the voltage output by the generator system 4. This may, in some embodiments, enable other circuitry traditionally used for voltage regulation—such as a DC-DC voltage regulator—to be eliminated or be reduced in size/capacity.

In some embodiments there is also a need to control the speed of rotation of a shaft 13 of the generator or motor-generator 11 when the generator or motor-generator 11 is generating and the generator system 3 is operating as a controlled rectifier 31. Accordingly, the speed of rotation of the propeller 12 may be adjusted. This may, in turn, have an impact on the speed of the fluid (e.g. drilling fluid (often called “mud” in relation to boreholes)) flowing past the propeller 12.

Accordingly, the operation of the braking chopper circuit 5 may result in a braking action with respect to the propeller 12 operation and any fluid driving the propeller 12. As such, in some such embodiments, the control system 4 may be configured to receive a signal indicative of a desired braking action. This signal may be received from an equipment control system, which is controlling aspects of the operation of the downhole equipment 1 (such as the steering of a steerable drill string of which the downhole equipment is a part). This signal may be a generator speed control signal, for example.

As will be appreciated, for the avoidance of doubt, the generator or motor-generator 11 may be part of a torquer or torquer-generator which may be used in the drill string. Indeed, a pair of generators or motor-generators 11 may be provided in the torquer or torquer-generator (e.g. with respective impellors 12 configured to rotate in opposing directions driven by the flow of a drilling fluid (e.g. mud)).

The signal indicative of the desired braking action may be determined, therefore, so as to provide a desired net torque, which is used to compensate for (or control) the reactive torque acting on a part of the downhole equipment 1 during operation of the drill string (e.g. through operation of a drill bit of the bottom hole assembly of the drill string or another part of the downhole equipment 1). For example, the signal indicative of the desired braking action may be such that the net torque on the generator system 3, the control system 4, and the braking chopper circuit 5 (which may be collectively referred to as control circuitry 3,4,5 and which may be in a control circuitry housing of the downhole equipment) may be controlled.

Accordingly, in some embodiments, the generator or motor-generator 11 may be used to control the relative roll position (i.e. the orientation about the longitudinal axis of the downhole equipment 1 or a part thereof) with respect to the borehole 2 and surrounding ground material. In some embodiments, the generator or motor-generator 11 may be used to maintain a substantially stationary rotational position of the control circuitry 3,4,5 and/or another part of the downhole equipment with respect to the borehole 2 and surrounding ground material.

The signal indicative of the desired braking action may be determined so as to reduce or control the electrical power which is generated by the generator or motor-generator 11 and delivered to the generator system 3. Accordingly, some embodiments, may be operative over wider ranges of fluid flow driving the impellor 12 (e.g. drilling fluid, such as mud or the like).

As will be appreciated, the same configuration may be used in other topologies of generator system 3, including inverters and/or controlled rectifiers 31 for providing three or more levels of voltage operation.

As will also be appreciated, the braking chopper circuit 5 has been described as such in relation to some embodiments due to the potential function in a braking operation. However, more generally, it will be understood that the braking chopper circuit 5 may be described as a chopper circuit 5.

Embodiments also include methods of perform the operations of the above described components of embodiments of the invention—either using those components or independently of some of those components (e.g. using other components of similar functionality).

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A generator system comprising:
a controlled rectifier configured to receive electrical power from a generator and to output rectified electrical power;
a control system configured to control the operation of the controlled rectifier; and
a chopper circuit connected to the output of the controlled rectifier and configured to connect a load selectively across the output of the controlled rectifier to regulate the output of the generator system, wherein the chopper circuit is controlled by the control system and the control system is configured to control the operation of the chopper circuit and/or the controlled rectifier based at least in part on a feedback signal representative of an electric current output by the generator system and an electric current passing through the chopper circuit.

2. A generator system according to claim 1, wherein the control system further includes a controller configured to compare the voltage output by the generator system with a predetermined voltage and to determine a further feedback signal based at least in part on the difference between the voltage output by the generator system and the predetermined voltage, and wherein the control system is further configured to control the operation of the chopper circuit and/or the controlled rectifier based on the further feedback signal.

3. A generator system according to claim 2, wherein the control system is configured to control the operation of the chopper circuit and/or the controlled rectifier based on the sum of the feedback signal and the further feedback signal.

4. A generator system according to claim 1, wherein the feedback signal is determined based at least in part on the sum of a signal representative of electric current output by the generator system and a signal representative of the electric current passing through the chopper circuit.

5. A generator system according to claim 1, wherein the control system includes a field oriented control module.

6. A generator system according to claim 1, wherein the control system is further configured to receive a generator speed control signal and to control the operation of the chopper circuit and/or the controlled rectifier based at least in part on the generator speed control signal.

7. A generator system according to claim 1, wherein the chopper circuit is configured to regulate the electric voltage output by the generator system.

8. A generator system according to claim 1, wherein the chopper circuit is configured to reduce the speed of rotation of a shaft of a generator coupled to the generator system.

9. A generator system and generator, wherein:
the generator system is a generator system according to any preceding claim; and
the generator is configured to supply electrical power to the generator system for conversion by the generator system into the output rectified electrical power.

10. A system according to claim 9, wherein the generator includes a three phase generator.

11. Downhole equipment including a generator system, comprising:
a controlled rectifier configured to receive electrical power from a generator and to output rectified electrical power;
a control system configured to control the operation of the controlled rectifier; and
a chopper circuit connected to the output of the controlled rectifier and configured to connect a load selectively across the output of the controlled rectifier to regulate the output of the generator system, wherein chopper circuit is controlled by the control system and the control system is configured to control the operation of the chopper circuit and/or the controlled rectifier based at least in part on a feedback signal representative of an electric current output by the generator system and an electric current passing through the chopper circuit.

12. The downhole equipment of claim 11, wherein the downhole equipment is configured to operate down a borehole.

13. A method of controlling a generator system, comprising:
receiving a feedback signal representative of an electric current output by the generator system and an electric current passing through a chopper circuit of the generator system; and
controlling the operation of a controlled rectifier and/or a chopper circuit based at least in part on the feedback signal, to provide a rectified electrical power output from the generator system.

14. A method according to claim 13, further comprising:
comparing the voltage output by the generator system with a predetermined voltage and to determine a further feedback signal based at least in part on the difference between the voltage output by the generator system and the predetermined voltage; and
controlling the operation of the chopper circuit and/or the controlled rectifier based on the further feedback signal.

15. A method according to claim 13, further comprising:
controlling the operation of the chopper circuit and/or the controlled rectifier based on the sum of the feedback signal and the further feedback signal.

16. A method according to claim 13, further comprising:
determining the feedback signal based at least in part on the sum of a signal representative of electric current output by the generator system and a signal representative of the electric current passing through the chopper circuit.

17. A method according to claim 13, wherein controlling the operation of the chopper circuit and/or the controlled rectifier includes using a field oriented control method.

18. A method according to claim 13, further comprising:
receiving a generator speed control signal; and
controlling the operation of the chopper circuit and/or the controlled rectifier based at least in part on the generator speed control signal.

19. A method according to claim 13, further comprising:
regulating the electric voltage output by the generator system using the chopper circuit.

20. A method according to claim 13, further comprising:
reducing the speed of rotation of a shaft of a generator coupled to the generator system using the chopper circuit.
